(19) United States
(12) Patent Application Publication
(10) Pub. No.: US 2023/0024250 A1
(43) Pub. Date: Jan. 26, 2023

(54) A WIRELESS RECEIVER

(71) Applicant: Agency for Science, Technology and Research, Singapore (SG)

(72) Inventors: Raju Salahuddin, Singapore (SG); Raja Kumarasamy, Singapore (SG); Dan Lei Yan, Singapore (SG)

(21) Appl. No.: 17/784,172

(22) PCT Filed: Dec. 10, 2019
(86) PCT No.: PCT/SG2019/050609

§ 371 Date: Jun. 10, 2022

(51) Int. Cl. H02J 50/27; H02J 50/40

(52) U.S. Cl. CPC H02J 50/27; H02J 50/402

(57) ABSTRACT

This disclosure relates to a power efficient wireless power receiver that is configured to receive and convert wireless power to direct-current (DC) power with minimal wastage. In particular, the receiver is able to selectively switch between a DC power combining topology and a radio-frequency (RF) power combining topology based on the amount of power that has been received so that the maximum amount of power received is optimized.

### FIELD OF THE INVENTION

This invention relates to a power efficient wireless power receiver that is configured to receive and convert wireless power to direct-current (DC) power with minimal wastage. In particular, the receiver is able to selectively switch between a DC power combining topology and a radio-frequency (RF) power combining topology based on the amount of power that has been received so that the maximum amount of power received is optimized.

### SUMMARY OF THE PRIOR ART

Advances in wireless technology have allowed electronic devices to be powered wirelessly. Such a degree of freedom allows strategically placed wireless power transceivers the ability to wirelessly provide power to a wide range of electronic devices such as wireless sensory nodes, Internet-of-Things (IoTs) devices and various other types of consumer electronics. Far-field wireless charging of these devices is significant as it aids in the wider adoption of IoT devices by consumers as such IoT devices are typically discreetly sized and are not connected to a power source.

Conventionally, when two coils are magnetically coupled together, power will be transferred wirelessly between these coils. However, the amount of transferred power reduces drastically once the distance between a transmitting and a receiving coil increases. In order to transmit power wirelessly over long distances, power is usually transmitted in the radio frequency (RF) range but due to omnidirectional nature of RF antennas, much of the transmitted power will be wasted. To address this, RF signals are typically beamed in the direction of the receiver and the receiver is usually tuned towards the transmitter so that the receiver is able to pick up the maximum amount of transmitted power. In order to achieve this, phase shifters are introduced to each antenna array so that wireless power can be beam formed in a specific direction.

In a wireless power receiver system, rectifiers are commonly used to convert wireless energy to DC power. The combination of an antenna and rectifier is known to those skilled in the art as a “rectenna”. In a practical scenario, power received by the rectenna may vary and the operating point may deviate from the optimal range causing the power efficiency to deteriorate as rectifiers will have an optimal power range at which the conversion efficiency of the rectifier maximizes.

Based on the above, it can be seen that the amount of usable power generated by a rectenna from received wireless power is dependent on the distance between the transmitter and the receiver as well as the optimal operating range of the rectifier. As a result, existing solutions require that wireless power receivers be located at a specific distance away from the wireless power transmitter and be configured to receive a specific amount of wireless power so that the device may be wirelessly charged in an efficient manner.

A wireless power transfer system is illustrated in FIG. 1 and the power received by a wireless power receiver 150 can be quantified as:

$${P}_{rx} = {P}_{tx} {G}_{tx} {{G}_{rx} ( \frac{λ}{4 π d} )}^{2} {η}_{rect} \qquad Equation ( 1 )$$

where, Pₜₓ is the power delivered to a transmitting antenna 110 by a power amplifier 115 that is driven by signal 120, Gₜₓ is the gain of the transmitting antenna 110, λ is the wavelength of an electromagnetic wave transmitted between the transmitter 105 and receiver 150, d is the distance between the transmitter 105 and the receiver 150, Gᵣₓ is the gain of the receiving antenna 160, and η_{rect} is the efficiency of the rectifier 165 that is used to convert wireless energy to DC power at load 170.

Based on equation (1) above, it can be seen that the received power can be increased via a number of ways; that is by increasing the gain of the transmitter and receiver, and by increasing the efficiency of the rectifier. However, as the received power is inversely dependent on the transmission distance d, as the receiver is located a distance away from the transmitter; the amount of receiver power will decrease accordingly. To ensure that the received power does not deteriorate too much over a large distance, antenna 110 usually comprises a high gain antenna that is set up in a phased-array configuration to focus wireless power in the direction of receiver 150. At receiver 150, antenna 160 is also beam-formed in the direction of transmitter 105 to increase the gain of antenna 160. In antenna array 160, the beamforming of the received wireless signal is achieved when the received wireless signal is combined at different phase angles.

For those above reasons, those skilled in the art are constantly striving to come up with a wireless power receiver that is able to operate in its optimal efficiency based on the amount of power received, regardless of the distance between the transmitter and the receiver. The wireless power receiver and methods associated with the wireless power receiver should also be able to operate in a battery-less manner whereby energy is obtained solely by harvesting RF energy.

### SUMMARY OF THE INVENTION

The above and other problems are solved and an advance in the art is made by systems and methods provided by embodiments in accordance with the invention.

A first advantage of embodiments of a receiver and methods in accordance with the invention is that the wireless receiver is able to receive wireless power efficiently over a large range, regardless whether the separation between the transmitter and receiver is large or small.

A second advantage of embodiments of a receiver and methods in accordance with the invention is that the wireless receiver is able to receive wireless power over a wide power range whereby at large power levels, the DC combining circuit is utilized and at lower power levels, the RF combining circuit is utilized thereby increasing the overall efficiency of the receiver.

A third advantage of embodiments of systems and methods in accordance with the invention is that the receiver circuit is scalable, and may be increased or decreased in size as required.

The above advantages are provided by embodiments of a device or method in accordance with the invention operating in the following manner.

According to a first aspect of the invention, a wireless power receiver is disclosed, the receiver comprising: a pair of antenna modules configured to receive wireless power; a switching module configured to connect the pair of antenna modules to a Direct Current (DC) combining circuit or a Radio Frequency (RF) combining circuit; a detector module configured to receive DC power P_{Rx} from the DC combining circuit or the RF combining circuit, wherein the detector module is configured to trigger the switching module to connect the pair of antenna modules to the DC combining circuit when the received power P_{Rx} exceeds a threshold power P_{Threshold}, and the detector module is configured to trigger the switching module to connect the pair of antenna modules to the RF combining circuit when the received power P_{Rx} is less than the threshold power P_{Threshold}.

With reference to the first aspect, the DC combining circuit comprises: a first and a second DC combining rectifier, whereby the first DC combining rectifier is configured to receive the wireless power from one of the antenna modules and the second DC combining rectifier is configured to receive the wireless power from another one of the antenna modules; and whereby the first and second DC combining rectifiers are configured to convert the wireless power from the pair of antenna modules to DC power P_{Rx} and to provide the DC power P_{Rx}, to the detector module.

With reference to the first aspect, the RF combining circuit comprises: a first and a second beam-forming module, whereby the first beam-forming module is configured to receive the wireless power from the one of the antenna modules and the second beam-forming module is configured to receive the wireless power from the another one of the antenna modules; and a RF combining rectifier configured to convert the beam-formed wireless power from the first and second beam-forming modules to DC power P_{Rx} and to provide the DC power P_{Rx}, to the detector module.

With reference to the first aspect, the first and second beam-forming modules are configured to optimize the wireless power received from the pair of antenna modules.

With reference to the first aspect, the first and second beam-forming modules each comprise a phase-shifter controllable by the detector module.

With reference to the first aspect, the one of the antenna modules comprises a pair of antennas and the another one of the antenna modules comprises another pair of antennas.

With reference to the first aspect, the switching module comprises a plurality of RF switches.

With reference to the first aspect, the one of the antenna modules comprises a pair of antennas and the another one of the antenna modules comprises another pair of antennas, and wherein the first and second beam-forming modules comprise a plurality of phase-shifters controllable by the detector module, whereby each phase-shifter is configured to transfer wireless power from an antenna to the RF combining rectifier.

With reference to the first aspect, the one of the antenna modules comprises a pair of antennas and the another one of the antenna modules comprises another pair of antennas; and wherein the DC combining circuit comprises: a first and a second beam-forming module, whereby the first beam-forming module is configured to receive the wireless power from the pair of antennas and the second beam-forming module is configured to receive the wireless power from the another pair of antennas; a first and a second DC combining rectifier, whereby the first DC combining rectifier is configured to receive the wireless power from the pair of antennas and the second DC combining rectifier is configured to receive the wireless power from the another pair of antennas; and whereby the first and second DC combining rectifiers are configured to convert the wireless power from the pair of antennas and the another pair of antennas to DC power P_{Rx} and to provide the DC power P_{Rx}, to the detector module.

According to a second aspect of the invention, a method for receiving wireless power is disclosed, the method comprising: receiving, using a pair of antennas modules, wireless power; selectively connecting, using a switching module, the pair of antennas modules to a Direct Current (DC) combining circuit or a Radio Frequency (RF) combining circuit; and receiving, using a detector module, DC power P_{Rx} from the DC combining circuit or the RF combining circuit, wherein the detector module is configured to trigger the switching module to connect the pair of antenna modules to the DC combining circuit when the received power P_{Rx} exceeds a threshold power P_{Threshold}, and is configured to trigger the switching module to connect the pair of antenna modules to the RF combining circuit when the received power P_{Rx} is less than the threshold power P_{Threshold}.

With reference to the second aspect, the DC combining circuit comprises: a first and a second DC combining rectifier, whereby the first DC combining rectifier is configured to receive the wireless power from one of the antenna modules and the second DC combining rectifier is configured to receive the wireless power from another one of the antenna modules; and whereby the first and second DC combining rectifiers are configured to convert the wireless power from the pair of antenna modules to DC power P_{Rx} and to provide the DC power P_{Rx}, to the detector module.

With reference to the second aspect, the RF combining circuit comprises: a first and a second beam-forming module, whereby the first beam-forming module is configured to receive the wireless power from the one of the antenna modules and the second beam-forming module is configured to receive the wireless power from the another one of the antenna modules; a RF combining rectifier configured to convert the beam-formed wireless power from the first and second beam-forming modules to DC power PRx and to provide the DC power PRx, to the detector module.

With reference to the second aspect, the first and second beam-forming modules are configured to optimize the wireless power received from the pair of antenna modules.

With reference to the second aspect, the first and second beam-forming modules each comprise a phase-shifter controllable by the detector module.

With reference to the second aspect, the one of the antenna modules comprises a pair of antennas and the another one of the antenna modules comprises another pair of antennas.

With reference to the second aspect, the switching module comprises a plurality of RF switches.

With reference to the second aspect, the one of the antenna modules comprises a pair of antennas and the another one of the antenna modules comprises another pair of antennas, and wherein the first and second beam-forming modules comprise a plurality of phase-shifters controllable by the detector module, whereby each phase-shifter is configured to transfer wireless power from an antenna to the RF combining rectifier.

### BRIEF DESCRIPTION OF THE DRAWINGS

The above advantages and features in accordance with this invention are described in the following detailed description and are shown in the following drawings:

FIG. 1 illustrating a system representative of a wireless power transmission system comprising a wireless power transmitter and a wireless power receiver as known by those skilled in the art;

FIG. 2 illustrating a receiver system comprising a radio frequency (RF) combining circuit whereby the receiver has been provided at an optimal operating range from the transmitter in accordance with embodiments of the invention;

FIG. 3 illustrating a plot showing the optimal operating range of a rectifier in accordance with embodiments of the invention;

FIG. 4 illustrating a receiver system comprising a direct-current (DC) combining circuit whereby each antenna is provided with an associated rectifier in accordance with embodiments of the invention;

FIG. 5 illustrating a block diagram of the wireless power receiver in accordance with an embodiment of the invention;

FIG. 6 illustrating another embodiment of the wireless power receiver illustrated in FIG. 5;

FIG. 7 illustrating a block diagram of the wireless power receiver in accordance with another embodiment of the invention;

FIG. 8 illustrating another embodiment of the wireless power receiver illustrated in FIG. 7;

FIG. 9 illustrating a flowchart of a process for receiving wireless power using the wireless power receiver in accordance with embodiments of the invention;

FIG. 10 illustrating a plot showing the received wireless power at the wireless power receiver in accordance with embodiments of the invention when the received power is low;

FIG. 11 illustrating a plot showing the receiving wireless power at the wireless power receiver in accordance with embodiments of the invention when the received power is high;

FIG. 12 illustrating a plot showing the received wireless power at the wireless power receiver when the wireless power receiver switches between a DC combining circuit and a RF combining circuit;

FIG. 13 illustrating a circuit diagram of a rectifier in accordance with embodiments of the invention;

FIG. 14 illustrating a circuit diagram of a RF switching module in accordance with embodiments of the invention; and

FIG. 15 illustrating a block diagram of a phase shifter in accordance with embodiments of the invention.

### DETAILED DESCRIPTION

This invention relates to a wireless power receiver that is configured to receive and convert wireless power to direct-current (DC) power in an efficient manner regardless of the distance between the transmitter and the receiver. In particular, the receiver is able to selectively switch between a DC power combining topology and a radio-frequency (RF) power combining topology based on the amount of power that has been received so that the maximum amount of power received may be optimized.

Hence, when the receiver determines that the received power is below a certain threshold, the receiver will utilize the RF combining circuit, which utilizes beamforming techniques, to ensure that the receiver receives the maximum amount of transmitted power by adjusting the received waveform accordingly. As the rectifier has low efficiency ratings, the beamforming approach is not efficient at higher power levels. Hence, when the receiver detects large power levels, the DC combining circuit which utilizes separate rectennas (i.e. an antenna coupled with a rectifier) to receive the wireless power will be utilized instead to maximize the amount of power received.

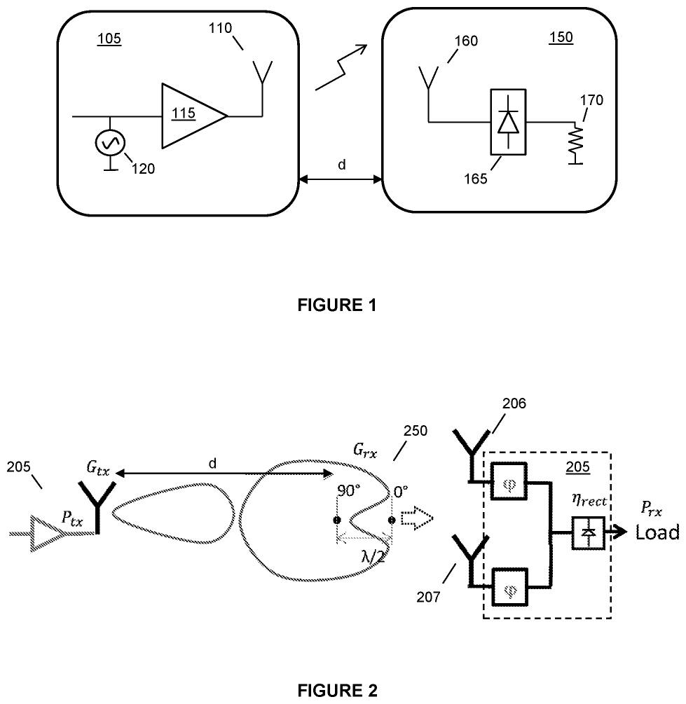

As mentioned in the previous section, a conventional wireless power transfer system is illustrated in FIG. 1. The system broadly comprises a transmitter 105 that is configured to transmit power wirelessly over a distance, d, to a receiver 150. Upon receiving the wireless power using antenna 160, receiver 150 then converts the received power using rectifier 165 to DC power at load 170.

FIG. 2 illustrates RF combining circuit 205 in accordance with embodiments of the invention. Circuit 205 comprises a pair of phase shifters, φ, which are each connected to an antenna 206 or 207 such that the phase shifters are able to beam form the wireless power received by the antennas to maximize the received power. Circuit 205 also includes a rectifier which is configured to convert the received-beam formed wireless power to DC power at the load. One skilled in the art will recognize that although only two antennas and two phase shifters are illustrated in circuit 205, any number of antennas and phase shifters may be utilized without departing from this invention. Various other beam forming techniques such as, but not limited to, digital beamforming approaches or analogue beamforming approaches may also be utilized in place of the phase shifters and these other techniques will be described in greater detail in the subsequent sections.

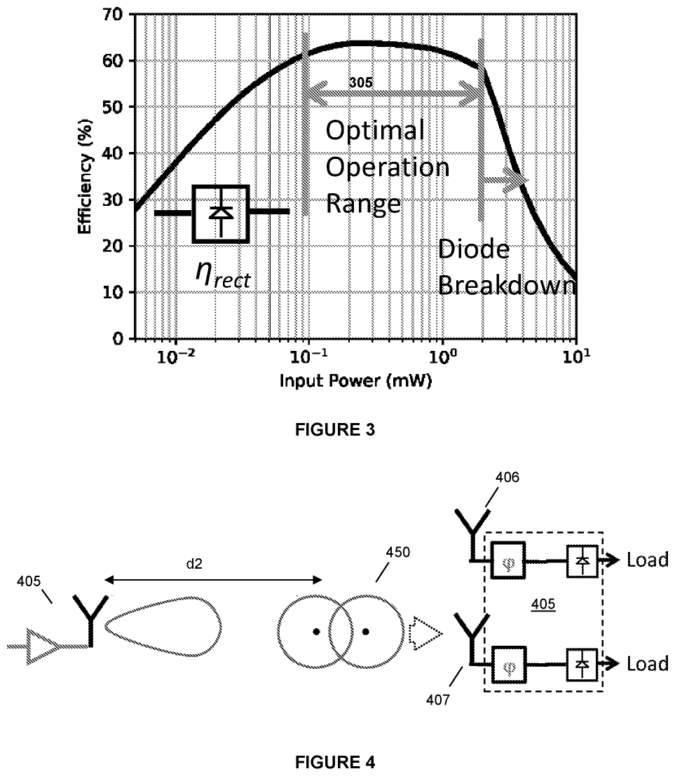

FIG. 2 also illustrates receiver 250 (that incorporates RF combining circuit 205) that is located at an optimal distance d, away from transmitter 205. At this distance, the received wireless power may be beam formed by RF combining circuit 205 to maximize the power received. It is useful at this stage to note that the efficiency of the wireless power transfer between transmitter 205 and receiver 250 may be affected by the properties and the variation in the properties of the wave front as received by the rectifier of circuit 205. A wave front which presents a coherent phase across the rectifier of circuit 205 may improve the efficiency of the transfer of wireless power, as less rectification of the received power may be needed thereby ensuring that the rectifier does not operate in its breakdown region (as shown in FIG. 3).

To achieve this, in accordance with embodiments of the invention, phase shifters in circuit 205 are configured to be 90° out-of-phase with each other such that the wireless power received by antenna 206 becomes 90° out-of-phase with the power received by antenna 207 once the received power has passed through the two phase shifters. The power that is coherently-phased is then rectified by the rectifier accordingly.

FIG. 3 illustrates the efficiency of an exemplary RF power to DC power rectifier when the power provided to the rectifier is varied between 0 and 100 mW. When the power provided to the rectifier is at the optimal range 305, it can be seen that the rectifier is highly efficient, converting the majority of the RF power to DC power. However, when the rectifier is driven too hard (i.e. provided with too large an input power), the efficiency of the rectifier will drop rapidly as the diode within would have entered its breakdown region thereby rendering the rectifier ineffective.

Hence, based on the plot shown in FIG. 3, it can be seen that the rectifier would not operate in an efficient manner once the received power exceeds a certain threshold, e.g. 20 mW for the rectifier illustrated in FIG. 3. One skilled in the art will recognize that other types of rectifiers having other optimal operating ranges may be used without departing from the invention.

FIG. 4 illustrates DC combining circuit 405 in accordance with embodiments of the invention. Circuit 405 comprises antenna 406 and 407 which are both connected to their own rectifiers and optionally to their own phase shifters whereby the power rectified by the respective rectifiers are then provided to a load. By providing each antenna with its own rectifier, this ensures that circuit 405 is able to handle receiving larger power levels without the rectifiers in circuit 405 ever having to operate in the diode breakdown region.

Hence, when receiver 450 (which incorporates DC combining circuit 405) is operated at a nearer distance d2 (as compared to distance d in FIG. 2) away from transmitter 405, receiver 450 is able to handle the larger power levels efficiently.

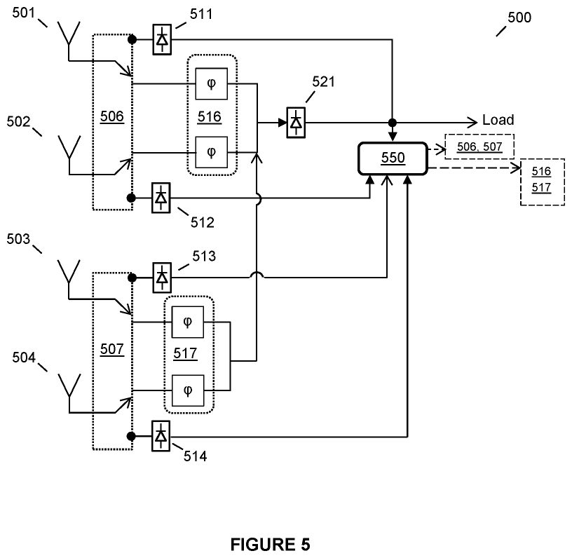

FIG. 5 illustrates a wireless power receiver 500 in accordance with an embodiment of the invention. In general, wireless power receiver 500 comprises antennas 501-504 that are configured to be connected to either a direct-current (DC) combining circuit or a radio frequency (RF) combining circuit through switching module 506 or 507 whereby detector module 550 determines the type of combining circuit that is to be connected to antennas 501-504 based on the amount of power detected by detector module 550.

Antennas 501-504 may comprise any type of antenna that is suitable for receiving and/or transmitting wireless power and switching modules 506, 507 may comprise any type of RF switches that are suitable for switching RF power. As illustrated in FIG. 5, the DC combining circuit comprises rectifiers 511-514 that are configured to convert RF power to DC power and once converted, provides this DC power to detector module 550. As for the RF combining circuit, this circuit comprises beamforming modules 516 and 517 that are configured to beam form the received power before the RF power is converted to DC power by rectifier 521 and subsequently provided to detector module 550. It should be noted that based on the amount of power detected by detector module 550, this module then controls the switching performed by switching modules 506 and 507 and the beam-forming functions performed by beamforming modules 516 and 517.

In accordance with embodiments of the invention, beamforming modules 516 and 517 may utilize analogue beamforming techniques to beam form the received waveforms. In particular, modules 516 and 517 may comprise phase shifters whose phases are controlled individually by detector module 550. Detector module 550 will then adjust the phases of each of the phase shifters so that the waveforms that pass through these phase shifters will combine constructively at rectifier 521 to maximize the amount of rectified power.

In operation, antennas 501-504 will each receive wireless power transmitted from a nearby transmitter. Under the assumption that receiver 500 is operating in a DC combining mode, i.e. the DC combining circuits are selected, the DC combining circuit will then cause the wireless power received to be rectified by each associated rectifier before the rectified signals are all summed and detected by detector module 550. In other words, the wireless power received by antenna 501 will be rectified by rectifier 511; the wireless power received by antenna 502 will be rectified by rectifier 512; the wireless power received by antenna 503 will be rectified by rectifier 513; the wireless power received by antenna 504 will be rectified by rectifier 514 and the sum of the DC power rectified by rectifiers 511-514 will then be provided to module 550.

If detector module 550 determines that the total received power is less than a predetermined threshold power, P_{Threshold}, detector module 550 will then cause switching modules 506 and 507 to connect antennas 501-504 to the RF combining circuit instead. In other words, the RF switches in switching modules 506 and 507 will switch their outputs from the DC combining circuit to the RF combining circuit. In embodiments of the invention, the predetermined threshold power, P_{Threshold}, is determined based on the breakdown power of the rectifiers 511-514 and 521 which may result in a P_{Threshold} value between 2 and 5 Volts.

When this happens, wireless power received by antennas 501-504 will instead be provided to beamforming modules 516 and 517 accordingly. Under the assumption that analogue beamforming techniques are adopted, phase shifters provided within beamforming modules 516 and 517 will then cause the received waveforms to be phase shifted. The phase shifted waveforms from beamforming modules 516 and 517 are then rectified by rectifier 521 and the rectified power is subsequently provided to detector module 550. Based on the received power, detector module 550 will then adjust the phases of the phase shifters in beamforming modules 516 and 517 such that the waveform provided to rectifier 521 is at its optimum coherent phase. The optimum rectified signal is then provided to detector module 550 and onto the load accordingly.

Conversely, if at any time detector module 550 determines that the total received power is more than the predetermined threshold power, P_{Threshold}, detector module 550 will then cause switching modules 506 and 507 to connect antennas 501-504 back to the DC combining circuit instead so that the individual rectifiers 511-514 will rectify the wireless power received by antennas 501-504 directly before summing the rectified DC power at detector module 550 and at the load.

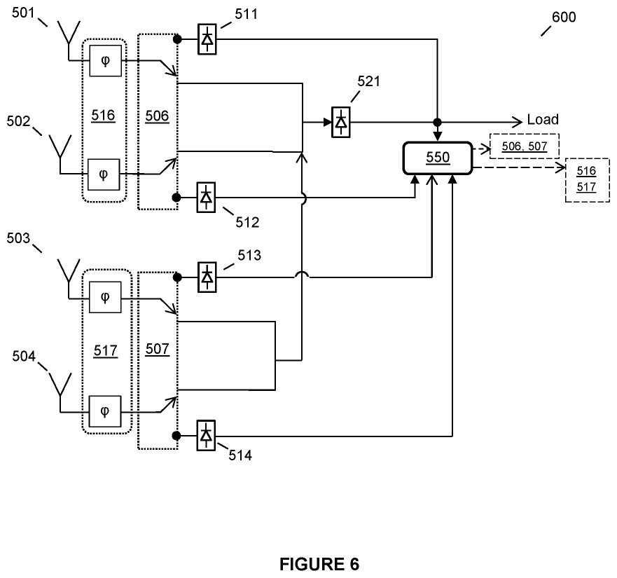

FIG. 6 illustrates another embodiment of the receiver illustrated in FIG. 5. For the receiver 600 illustrated in FIG. 6, the beamforming modules are provided between the antennas and the switching modules instead. In operation, the various components within receiver 600 operate in the similar manner as the components in receiver 500. In particular, detector module 550 is configured to vary the phases of the phase shifters in beamforming modules 516 and 517 such that the waveform that is provided to rectifier 521 is optimized when the RF combining circuit is selected; the rectifiers 511-514 are configured to rectify the wireless power received by antennas 501-504 directly before summing the rectified DC power at detector module 550 when the DC combining circuit is selected; and detector module 550 is configured to cause switching modules 506 and 507 to switch between the RF and DC combining circuits based on the power received by module 550.

One skilled in the art will recognize that wireless power receivers 500 and 600 may comprise of any number of antennas without departing from the invention. This means that when the number of antennas increases, the number of switching modules, the number of rectifiers in DC combining circuit and the number of beamforming modules will have to be increased accordingly and conversely, when the number of antennas decreases, the number of switching modules, the number of rectifiers in DC combining circuit and the number of beamforming modules will have to be reduced accordingly.

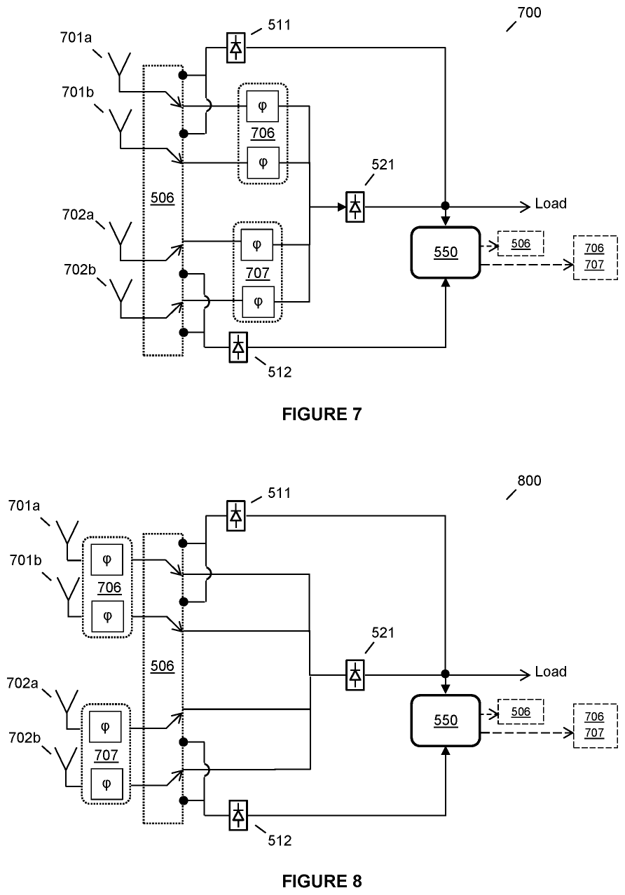

FIG. 7 illustrates wireless power receiver 700 which is yet another embodiment of the invention. Wireless power receiver 700 comprises antennas 701a, 701b, 702a and 702b that are configured to be connected to either a direct-current (DC) combining circuit or a radio frequency (RF) combining circuit through switching module 506 whereby detector module 550 determines the type of combining circuit that is to be connected to antennas 701a, 701b, 702a and 702b based on the amount of power detected by detector module 550.

As illustrated in FIG. 7, the DC combining circuit comprises rectifiers 511-512 that are configured to convert RF power to DC power and once converted, provides this DC power to detector module 550. As for the RF combining circuit, this circuit comprises beamforming modules 706 and 707 that are configured to beam form the received power before the RF power is converted to DC power by rectifier 521 and subsequently provided to detector module 550. It should be noted that based on the amount of power detected by detector module 550, this module then controls the switching performed by switching module 506 and the beam-forming functions performed by beamforming modules 706 and 707.

In accordance with embodiments of the invention, beamforming modules 706 and 707 may utilize analogue or digital beamforming techniques to beam form the received waveforms as previously discussed however for brevity, it is assumed that analogues beamforming techniques are adopted for receiver 700.

In operation, antennas 701a and 701b will each receive wireless power transmitted from a nearby transmitter. Under the assumption that receiver 700 is operating in a DC combining mode, i.e. the DC combining circuits are selected, the DC combining circuit will then cause the wireless power received by antennas 701a and 701b to be rectified by rectifier 511. Similarly, the DC combining circuit will then cause the wireless power received by antennas 702a and 702b to be rectified by rectifier 512. The rectifier power from rectifiers 511 and 512 are then summed at detector module 550 and provided to the load.

If detector module 550 determines that the total received power is less than a predetermined threshold power, P_{Threshold}, detector module 550 will then cause switching module 506 to connect antennas 701a, 701b, 702a and 702b to the RF combining circuit instead. In other words, the RF switches in switching module 506 will switch their outputs from the DC combining circuit to the RF combining circuit.

When this happens, wireless power received by antennas 701a, 701b, 702a and 702b will be provided to beamforming modules 706 and 707 instead. Under the assumption that analogue beamforming techniques are adopted, phase shifters provided within beamforming modules 706 and 707 will then cause the received waveforms to be phase shifted. The phase shifted waveforms from beamforming modules 706 and 707 are then rectified by rectifier 521 and the rectified power is subsequently provided to detector module 550. Based on the received power, detector module 550 will then adjust the phases of the phase shifters in beamforming modules 706 and 707 such that the waveform provided to rectifier 521 is at its optimum coherent phase. The optimum rectified signal is then provided to detector module 550 and onto the load accordingly.

Conversely, if at any time detector module 550 determines that the total received power is more than the predetermined threshold power, P_{Threshold}, detector module 550 will then cause switching module 506 to connect antennas 701a, 701b, 702a and 702b back to the DC combining circuit instead so that the rectifiers 511 and 512 will rectify the wireless power received by antennas 701a, 701b, 702a and 702b directly before summing the rectified DC power at detector module 550 and at the load.

FIG. 8 illustrates another embodiment of the receiver illustrated in FIG. 7. For the receiver 800 illustrated in FIG. 8, the beamforming modules are provided between the antennas and the switching module instead. In operation, the various components within receiver 800 operate generally in the similar manner as the components in receiver 700.

The main difference is that the waveforms received by 701a and 701b are beamformed by beamforming module 706 regardless whether the RF or DC combining circuits are selected.

In operation, antennas 701a and 701b will each receive wireless power transmitted from a nearby transmitter. Under the assumption that receiver 700 is operating in a DC combining mode, i.e. the DC combining circuits are selected, the DC combining circuit will then cause the wireless power received by antennas 701a and 701b to be beamformed by beamforming module 706 before the beamformed waveform is rectified by rectifier 511. Similarly, the DC combining circuit will then cause the wireless power received by antennas 702a and 702b to be beamformed by beamforming module 706 before the beamformed waveform is rectified by rectifier 512. The rectifier power from rectifiers 511 and 512 are then summed at detector module 550 and provided to the load. Based on the received power, detector module 550 will then adjust the phases of the phase shifters in beamforming modules 706 and 707 such that the waveform provided to rectifier 521 is at its optimum coherent phase. The optimum rectified signal is then provided to detector module 550 and onto the load accordingly

If detector module 550 determines that the total received power is less than a predetermined threshold power, P Threshold detector module 550 will then cause switching module 506 to connect antennas 701a, 701b, 702a and 702b to the RF combining circuit instead. In other words, the RF switches in switching module 506 will switch their outputs from the DC combining circuit to the RF combining circuit.

When this happens, wireless power received by antennas 701a, 701b, 702a and 702b will be provided to beamforming modules 706 and 707 instead. Under the assumption that analogue beamforming techniques are adopted, phase shifters provided within beamforming modules 706 and 707 will then cause the received waveforms to be phase shifted. The phase shifted waveforms from beamforming modules 706 and 707 are then rectified by rectifier 521 and the rectified power is subsequently provided to detector module 550. Based on the received power, detector module 550 will then adjust the phases of the phase shifters in beamforming modules 706 and 707 such that the waveform provided to rectifier 521 is at its optimum coherent phase. The optimum rectified signal is then provided to detector module 550 and onto the load accordingly.

Conversely, if at any time detector module 550 determines that the total received power is more than the predetermined threshold power, P_{Threshold}, detector module 550 will then cause switching module 506 to connect antennas 701a, 701b, 702a and 702b back to the DC combining circuit instead so that the rectifiers 511 and 512 will rectify the wireless power received by antennas 701a, 701b, 702a and 702b directly before summing the rectified DC power at detector module 550 and at the load.

One skilled in the art will recognize that wireless power receivers 700 and 800 may comprise of any number of antennas without departing from the invention and when the number of antennas increases, the number of switching modules, the number of rectifiers in DC combining circuit and the number of beamforming modules will have to be increased accordingly.

In accordance with embodiments of the invention, a method for receiving wireless power using components in a wireless power receiver comprises the following steps:

Step 1, receiving, using a pair of antennas modules, wireless power;

Step 2, selectively connecting, using a switching module, the pair of antennas modules to a Direct Current (DC) combining circuit or a Radio Frequency (RF) combining circuit; and

Step 3, receiving, using a detector module, DC power P_{Rx} from the DC combining circuit or the RF combining circuit, wherein the detector module is configured to trigger the switching module to connect the pair of antenna modules to the DC combining circuit when the received power P_{Rx} exceeds a threshold power P_{Threshold}, and is configured to trigger the switching module to connect the pair of antenna modules to the RF combining circuit when the received power P_{Rx} is less than the threshold power P_{Threshold}.

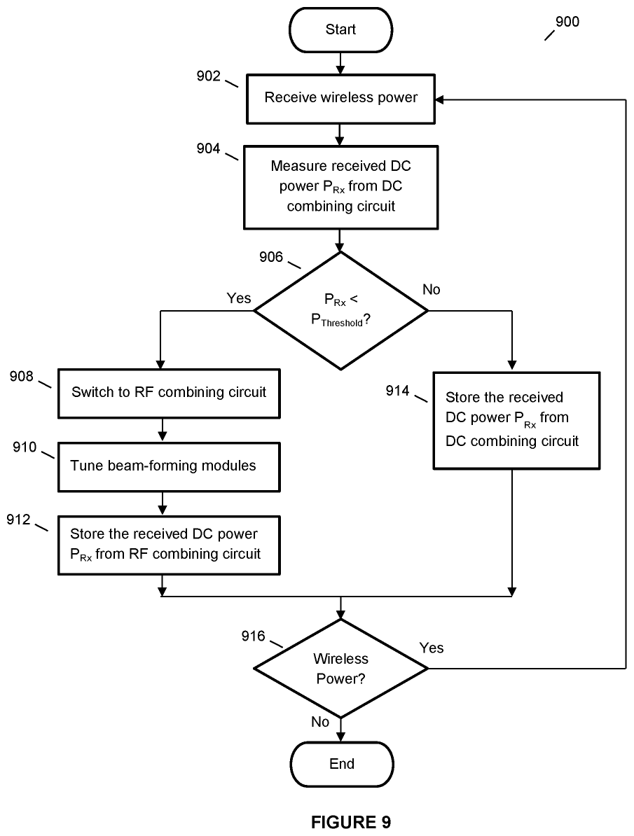

In embodiments of the invention, a process is needed for receiving wireless power using components in a wireless power receiver. The following description and FIG. 9 describes embodiments of processes in accordance with this invention.

Process 900 begins at step 902 whereby wireless power is received. Process 900 then measures the DC power P_{Rx} produced by a DC combining circuit. If process 900 determines at step 906 that the DC power P_{Rx} is less than a threshold power P_{Threshold}, process 900 then progresses to step 908 whereby process 900 switches the combining circuit to the RF combining circuit from the DC combining circuit. Process 900 then fine tunes the beam-forming modules at step 910 to ensure that the waveform is coherent. The rectified power received from the RF combining circuit is then stored in a load at step 912. If wireless power is detected at step 916, process 900 then returns to step 902 and all the processes repeat until no further wireless power is detected at step 916. Process 900 then ends.

Alternatively, if process 900 determines at step 906 that the DC power P_{Rx} is more than a threshold power P_{Threshold}, process 900 then progresses to step 914 whereby the received power is provided to a load and process 900 then progresses to step 916. Similarly, if wireless power is detected at step 916, process 900 then returns to step 902 and all the processes repeat until no further wireless power is detected at step 916. Process 900 then ends.

### Simulated Results for the RF and DC Combining Circuits

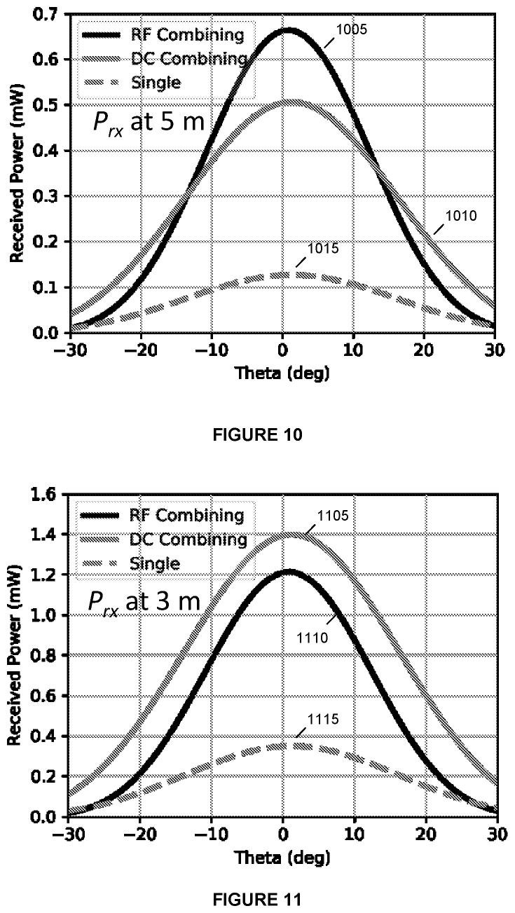

FIG. 10 illustrates the received power detected by a wireless receiver in accordance with embodiments of the invention when the separation between the transmitter and the receiver is large, i.e. around 5 m apart. At this distance, it can be seen that the maximum received power is about 0.65 mW and this is achieved when the RF combining circuit is selected by the wireless power receiver. The received power when the RF combining circuit is selected is plotted as plot 1005 and the received power when the DC combining circuit is selected is plotted as plot 1010. It can be clearly seen that at larger distances and at lower power levels, it is more advantageous for the RF combining circuit to be utilized by the wireless power receiver. As a reference, plot 1015 illustrates the received power when both RF and DC combining circuits were not used.

FIG. 11 illustrates the received power detected by a wireless receiver in accordance with embodiments of the invention when the separation between the transmitter and the receiver is smaller, i.e. around 3 m apart. At this distance, it can be seen that the maximum received power is higher, at about 1.4 mW and this is achieved when the DC combining circuit is selected by the wireless power receiver. The received power when the RF combining circuit is selected is plotted as plot 1105 and the received power when the DC combining circuit is selected is plotted as plot 1110. It can be clearly seen that at shorter distances and at higher power levels, it is more advantageous for the DC combining circuit to be utilized by the wireless power receiver. As a reference, plot 1115 illustrates the received power when both RF and DC combining circuits were not used.

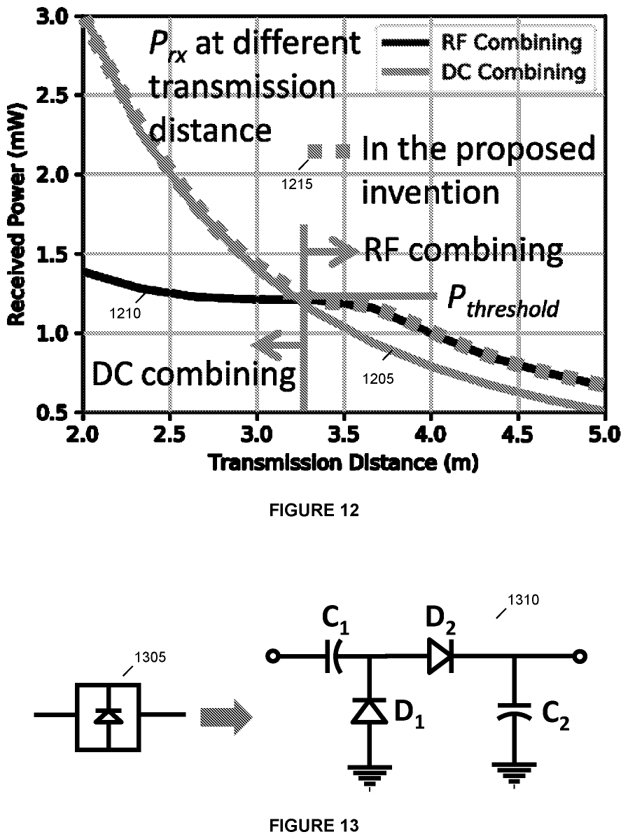

Based on the plots illustrated in FIGS. 10 and 11, it is understood that the wireless power receiver will perform best when the RF and DC combining circuits are selectively used, depending on the amount of power received and the separation between the receiver and the transmitter. This is better illustrated in FIG. 12 which shows the overall received power when the RF and DC combining circuits are used over varying transmission distances. Plot 1205 shows the power received when the DC combining circuit is used and plot 1210 shows the power received when the RF combining circuit is used. Plot 1215 illustrates the total received power when the RF and DC combining circuits are selectively used thereby ensuring that the amount of received power remains optimum throughout.

The rectifiers referred in this disclosure are realized by a combination of diode circuits which individually have a very low resistance when switched ON resulting in low isolation levels between its output and input. In an embodiment of the invention, the rectifier's circuit and/or the phase shifter's circuit may be used to dynamically match the antenna to 50-Ohms at different power levels.

An embodiment of the rectifier circuit is shown in FIG. 13. To those skilled in the art, rectifier circuit 1310 is referred to as a voltage multiplier. Although only one topology of rectifier 1305 is illustrated in FIG. 13, one skilled in the art will recognize that various rectifier topologies can be used to achieve the required functionality without departing from the invention. The rectifier topologies include, but are not limited to, half-wave, full-wave, single shunt, single stage voltage multiplier, Cockcroft-Walton/Greinacher/Villard charge pump, Dickson charge pump, etc.

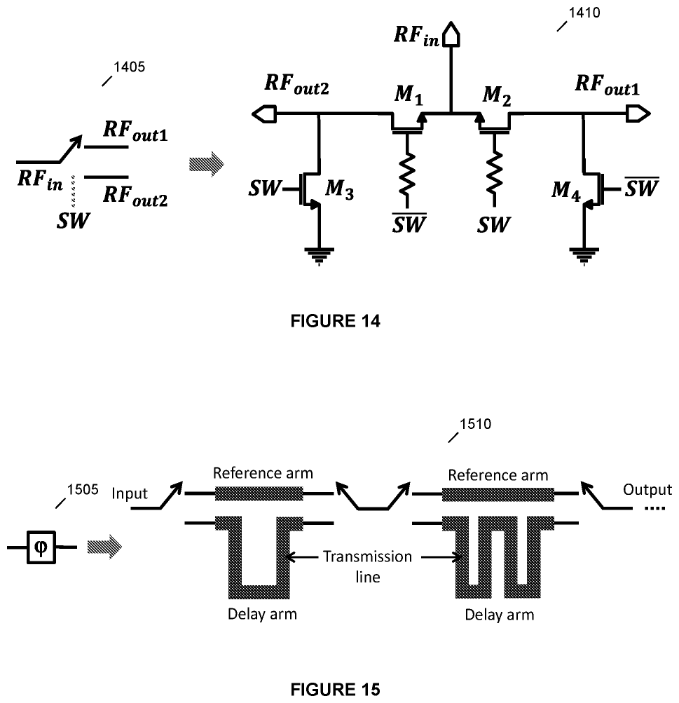

An embodiment of the switching module 1405 is illustrated in FIG. 14 as circuit 1410. One skilled in the art will recognize that other kinds of RF switches, such as PIN diode or MEMS switches may be utilized to achieve the functionality of the invention.

An embodiment of a RF phase shifter 1505 is shown in FIG. 15. In topology 1510, the phase of an RF signal can be controlled to combine the RF signals from different antenna elements. The phase shifter topologies to achieve the functionality of the disclosure include, but are not limited to, lumped element phase shifter, quadrature phase shifter, distributed phase shifter, switched low-pass and high-pass phase shifter, varactor controlled phase shifter, loaded transmission line phase shifter, reflection type phase shifter, etc.

The above is a description of embodiments of a device and method in accordance with the present invention as set forth in the following claims. It is envisioned that others may and will design alternatives that fall within the scope of the following claims.

1. A wireless power receiver comprising:
a pair of antenna modules configured to receive wireless power;
a switching module configured to connect the pair of antenna modules to a Direct Current (DC) combining circuit or a Radio Frequency (RF) combining circuit;
a detector module configured to receive DC power P_{Rx} from the DC combining circuit or the RF combining circuit, wherein the detector module is configured to trigger the switching module to connect the pair of antenna modules to the DC combining circuit when the received power P_{Rx} exceeds a threshold power P_{Threshold}, and the detector module is configured to trigger the switching module to connect the pair of antenna modules to the RF combining circuit when the received power P_{Rx} is less than the threshold power P_{Threshold}.

2. The wireless power receiver according to claim 1 wherein the DC combining circuit comprises:
a first and a second DC combining rectifier, whereby the first DC combining rectifier is configured to receive the wireless power from one of the antenna modules and the second DC combining rectifier is configured to receive the wireless power from another one of the antenna modules; and
whereby the first and second DC combining rectifiers are configured to convert the wireless power from the pair of antenna modules to DC power P_{Rx} and to provide the DC power P_{Rx}, to the detector module.

3. The wireless power receiver according to claim 1, wherein the RF combining circuit comprises:
a first and a second beam-forming module, whereby the first beam-forming module is configured to receive the wireless power from the one of the antenna modules and the second beam-forming module is configured to receive the wireless power from the another one of the antenna modules; and
a RF combining rectifier configured to convert the beam-formed wireless power from the first and second beam-forming modules to DC power P_{Rx} and to provide the DC power P_{Rx}, to the detector module.

4. The wireless power receiver according to claim 3 whereby the first and second beam-forming modules are configured to optimize the wireless power received from the pair of antenna modules.

5. The wireless power receiver according to claim 4, wherein the first and second beam-forming modules each comprise a phase-shifter controllable by the detector module.

6. The wireless power receiver according to claim 1 whereby the one of the antenna modules comprises a pair of antennas and the another one of the antenna modules comprises another pair of antennas.

7. The wireless power receiver according to claim 1 wherein the switching module comprises a plurality of RF switches.

8. The wireless power receiver according to claim 3 whereby the one of the antenna modules comprises a pair of antennas and the another one of the antenna modules comprises another pair of antennas, and wherein the first and second beam-forming modules comprise a plurality of phase-shifters controllable by the detector module, whereby each phase-shifter is configured to transfer wireless power from an antenna to the RF combining rectifier.

9. The wireless power receiver according to claim 1 whereby the one of the antenna modules comprises a pair of antennas and the another one of the antenna modules comprises another pair of antennas; and
wherein the DC combining circuit comprises:
a first and a second beam-forming module, whereby the first beam-forming module is configured to receive the wireless power from the pair of antennas and the second beam-forming module is configured to receive the wireless power from the another pair of antennas;
a first and a second DC combining rectifier, whereby the first DC combining rectifier is configured to receive the wireless power from the pair of antennas and the second DC combining rectifier is configured to receive the wireless power from the another pair of antennas; and
whereby the first and second DC combining rectifiers are configured to convert the wireless power from the pair of antennas and the another pair of antennas to DC power P_{Rx} and to provide the DC power P_{Rx}, to the detector module.

10. A method for receiving wireless power comprising:
receiving, using a pair of antennas modules, wireless power;
selectively connecting, using a switching module, the pair of antennas modules to a Direct Current (DC) combining circuit or a Radio Frequency (RF) combining circuit; and
receiving, using a detector module, DC power P_{Rx} from the DC combining circuit or the RF combining circuit, wherein the detector module is configured to trigger the switching module to connect the pair of antenna modules to the DC combining circuit when the received power P_{Rx} exceeds a threshold power P_{Threshold}, and is configured to trigger the switching module to connect the pair of antenna modules to the RF combining circuit when the received power P_{Rx} is less than the threshold power P_{Threshold}.

11. The method according to claim 10 wherein the DC combining circuit comprises:
a first and a second DC combining rectifier, whereby the first DC combining rectifier is configured to receive the wireless power from one of the antenna modules and the second DC combining rectifier is configured to receive the wireless power from another one of the antenna modules; and
whereby the first and second DC combining rectifiers are configured to convert the wireless power from the pair of antenna modules to DC power P_{Rx} and to provide the DC power P_{Rx}, to the detector module.

12. The method according to claim 10, wherein the RF combining circuit comprises:
a first and a second beam-forming module, whereby the first beam-forming module is configured to receive the wireless power from the one of the antenna modules and the second beam-forming module is configured to receive the wireless power from the another one of the antenna modules;
a RF combining rectifier configured to convert the beam-formed wireless power from the first and second beam-forming modules to DC power P_{Rx} and to provide the DC power P_{Rx}, to the detector module.

13. The method according to claim 12 whereby the first and second beam-forming modules are configured to optimize the wireless power received from the pair of antenna modules.

14. The method according to claim 12, wherein the first and second beam-forming modules each comprise a phase-shifter controllable by the detector module.

15. The method according to claim 10 whereby the one of the antenna modules comprises a pair of antennas and the another one of the antenna modules comprises another pair of antennas.

16. The method according to claim 10 wherein the switching module comprises a plurality of RF switches.

17. The method according to claim 12 whereby the one of the antenna modules comprises a pair of antennas and the another one of the antenna modules comprises another pair of antennas, and wherein the first and second beam-forming modules comprise a plurality of phase-shifters controllable by the detector module, whereby each phase-shifter is configured to transfer wireless power from an antenna to the RF combining rectifier.
